(19) United States
(12) Patent Application Publication
(10) Pub. No.: US 2009/0267755 A1
(43) Pub. Date: Oct. 29, 2009

(54) Method and warning alarm device, smoke detector in particular

(76) Inventor: Gerhard Ropke, Travemunde (DE)

Correspondence Address: VIDAS, ARRETT & STEINKRAUS, P.A., SUITE 400, 6640 SHADY OAK ROAD, EDEN PRAIRIE, MN, 55344, US

(21) Appl. No.: 12/406,257

(22) Filed: Mar. 18, 2009

(30) Foreign Application Priority Data
Mar. 19, 2008 (DE) 10 2008 014 991.8

(51) Int. Cl. G08B 29/00

(52) U.S. Cl. 340/514

(57) ABSTRACT

A method for testing the free entrance of gas into a measuring cavity of a warning alarm device via at least one opening, wherein an acoustic signal is generated in the measuring cavity and the change of the resonance behaviour of the measuring cavity is measured in order to emit an error signal when the resonance behaviour has changed in a measurable degree, wherein the number of the oscillations of the acoustic signal is measured after the termination of the acoustic signal, and is compared with a preset value.

### CROSS-REFERENCE TO RELATED APPLICATIONS

Not applicable

### STATEMENT REGARDING FEDERALLY SPONSORED RESEARCH

Not applicable

### BACKGROUND OF THE INVENTION

The present invention is related to a method for testing the free entrance of gas into a measuring cavity of a warning alarm device. The present invention is further related to a warning alarm device, a smoke detector in particular.

A variety of different danger- or warning alarm devices have become known, which are all based on the principle to detect the entrance of gas and/or smoke into a measuring cavity and to emit a warning signal when a deviation from a desired condition is detected. The warning signal can be emitted acoustically, optically or in another way. Such danger- or warning alarm devices are usually installed on a wall and/or a ceiling in buildings. The detector device is located inside the measuring cavity, an optical measurement device for instance. It is known to provide the openings with a screen or trellis, so that no dirt or no insects intrude into the entrance openings to the measuring cavity.

When there is a greater or longer lasting formation of dust in the atmosphere or appearance of insects, a clogging of the screen or trellis may easily occur, so that the occurrence of a danger can not or only too lately be notified. Furthermore, the entrance openings of such danger alarm devices can be closed with an adhesive tape or the like, when paint brushing operations are to be performed in the building and paint is to be prevented from entering into the measuring cavity. Now, it has become known from JP 2128298, the entire contents of which is incorporated herein by reference, to introduce an acoustical signal into the measuring cavity with the aid of a sound generator, and to determine whether a resonance detuning takes place in the space of the measuring cavity. The same is analysed via the current of an oscillator circuit which excites the sound generator, a piezo element for instance.

From EP 1 870 866 or EP 1 857 989, the entire contents of which is incorporated herein by reference, it is known to test the permeability of the entrance openings to the measuring cavity in an optical manner. However, when the entrance opening is closed with a protection sheet or an adhesive tape, this can not be detected with optical elements on the smoke entrance openings, because the coverings are situated on the outside of the danger warning device.

From DE 201 08 451 U1, the entire contents of which is incorporated herein by reference, an optical smoke warning device is known, which features a sound generator in the form of a piezo element in the measuring cavity. The sound generator serves for the generation of an alarm sound, wherein the space of the measuring cavity is used as a resonance body. There is no monitoring of the entrance openings or of a corresponding screen or trellis at the entrance opening, respectively. From DE 8 210 633 U1, the entire contents of which is incorporated herein by reference, a fire warning device has become known, in which the measuring cavity is equipped with a sound generator in the infrasound range. Plural connection openings are provided between the sound generator cavity and the measuring cavity, which are equipped with valves, so that the movement of the sound generator membrane generates a negative pressure in the measuring cavity and the air of the surroundings is aspirated into the measuring cavity. Through this, even smoke particles can arrive in the measuring cavity, which move only slowly in the air of the surroundings of the smoke warning device. There is no measurement of the soiling of entrance openings into the measuring cavity.

The present invention is based on the objective to provide a method for testing the free entrance of gas into a measuring cavity of a warning- or danger alarm device via at least one opening, which can be performed simply and safely even in an automatic manner, and which does not compromise the surroundings.

In the method of the present invention, the number of the oscillations of the acoustic signal is measured after the termination of the acoustic signal, and is compared with a preset value. Preferably, the acoustic signal is generated for a short period of time.

As the sound generator, a piezo disc can be used for instance. The excitation phase for the sound generator can be a few oscillations only in the region of the resonance frequency. Thus, for instance, the piezo disc is excited with 20 oscillations. This has the advantage that the testing operation requires only minimum energy and the generated sound appears only for a short period of time. By doing so, the sound is practically not perceivable and a testing is not disturbing for persons in the surroundings.

### SUMMARY OF THE INVENTION

The present invention is based on the finding that the sound generator or the piezo disc, respectively, continues to oscillate with a decreasing amplitude after the termination of the excitation phase. The decay of the amplitude is influenced by the resonance frequency, the sound generator, the measuring cavity and the entrance openings.

In other words, even entrance openings which are partially closed by dust or a sheet result in a damping of the decay process of the piezo element. As a consequence, the die away phase is more or less significantly shorter, depending on the degree of impermeability of the entrance openings. Therefore, the number of oscillations after the end of the acoustical signal is counted and compared with a preset value. For instance, this preset value is the number of the decaying oscillations in the new or unsoiled condition of the warning alarm device. This value is memorised in a suitable circuitry of the warning alarm device, and in the testing operation, the measured number of oscillations is compared with the memorised value. When the difference exceeds a preset value, an error signal is generated.

According to one embodiment of the present invention, the acoustic signal is preferably generated in a cyclic manner. After each acoustic signal, the measurement of the decaying oscillations takes place after the end thereof.

The present invention is also related to a warning alarm device, which is characterised in that a control device for the excitation of a sound generator interrupts the triggering of the sound generator and a counting device in an error measurement device counts the number of the decaying oscillations after the interruption of the excitation of the sound generator, and the error measurement device generates an error signal when the oscillation number is below a preset value. As already mentioned, the sound generator is preferably a piezo disc. According to a further embodiment of the present invention, it is situated behind an opening in an upper wall of the measuring cavity.

According to a further embodiment of the present invention, the sound generator can be a sound generator of the measurement device at the same time. It is known to equip such warning- or danger alarm devices with a sound generator which emits an alarm sound when a danger has been detected.

Several possibilities are conceivable to trigger a piezo disc via an oscillator. One of them is, according to the present invention, to arrange the piezo disc in the shunt arm of an H-bridge circuit which is connected to an oscillator.

There are different possibilities to count the decaying oscillations. According to the present invention, one of them is to convert the oscillations into digital signals, whose number then determines whether the entrance openings can still be considered as a free entrance or not.

Instead of counting the oscillations during the decay process, it is also conceivable to preset a threshold value, which is reached or fallen below, respectively, in order to indicate that the decay process is essentially terminated. For instance, when the threshold value is reached or fallen below in a period of time which is smaller than the period of time which a piezo disc needs for decaying when the entrance opening is free, an error signal can be generated also.

The present invention is depicted by means of drawings in the following and explained in more detail by an example of its realisation.

### BRIEF DESCRIPTION OF THE SEVERAL VIEWS OF THE DRAWINGS

FIG. 1 shows a section through a warning alarm device according to the present invention;

FIG. 2 shows a block circuit diagram of a circuitry for the warning alarm device of Fig.;

FIG. 3 shows the course of the oscillation of a piezo element of the circuitry of FIG. 2; and

FIG. 4 shows the conversion of the oscillations of FIG. 3 into digital impulses.

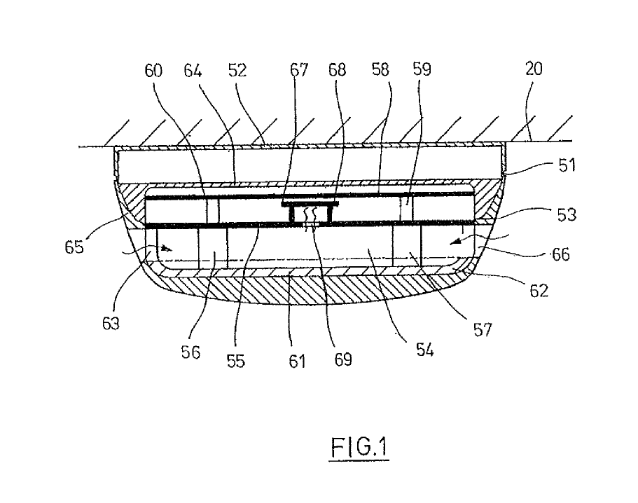

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

A casing 65 made of plastic material is mounted at 51 on a socket 52, which is fastened on a ceiling 10 in a not shown manner. The casing 65 is held by a flange part 64 which is connected to the socket 52. Details of this are not dwelled on in more detail, because they are commonly known. A first wall portion 58 is attached inside of the flange part, and a second parallel wall portion 53 is connected to the first wall portion 58 via struts 59, 60. The lower wall portion 55 features an opening or a hole 69. Above the hole, in the interspace between the wall portions 58, 55, there is a piezo disc 68 on a socket, which is supported on the wall portion 55; the piezo disc projects laterally, as is shown at 67. A measuring cavity 54 is formed in the casing 65, with an optical sender 56 and an optical receiver 57, as is commonly known for optical smoke alarm devices. Even for this, details are not indicated. The optical measurement device is located on a plate 62 which is arranged on the bottom of the measuring cavity 54. Lateral entrance openings 63 for air or gas, respectively, can be recognised towards the measuring cavity. The gas enters approximately according to the arrow 66. As soon as aerosols in the gas or other particles change the reception of the light from the optical sender 56, an error signal is generated, as is per se known. The electronic circuitry necessary for this is not depicted.

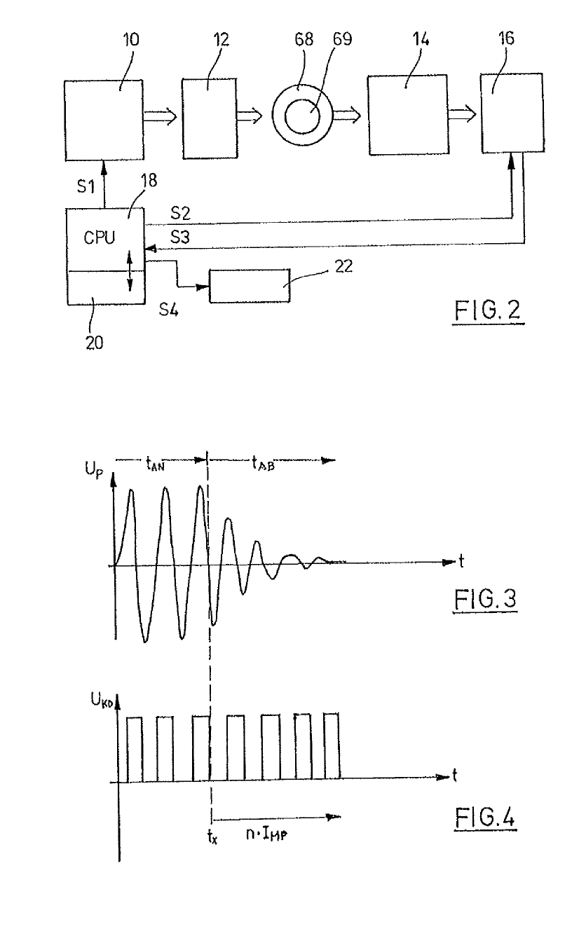

The piezo disc 68 serves as a sound generator for generating a danger signal through the electronic danger- or warning alarm circuitry on the one hand. On the other hand, the piezo disc 68 serves as a testing element for the permeability of the entrance openings 63 for gas. The latter ones are usually provided with a trellis or a screen (not shown), which prevents dirt particles or insects from arriving in the interior of the measuring cavity 54. However, such screens or trellises may become clogged in the course of time, or they may be closed up by a tape when it is worked with paint in that room of the building in which the warning device is arranged. With the aid of a suitable circuitry and of the sound generator 68, it can be detected whether a sufficient permeability exists. Such a circuitry can be recognised in FIG. 2. Here it is shown how an oscillator 10, which is connected to a bridge circuit 12, excites the piezo disc 68 to oscillations. The oscillations are captured by a comparator 14 and converted into digital signals, which are counted in a counting device 16. The triggering of the oscillator 10 takes place via a digital processor 18 which has also a memory 20.

In FIG. 3 it is indicated how the processor 18 excites the oscillator 10 for a short period of time. The excitation time is indicated as tₐₙ and amounts to 20 oscillations for instance. The frequency is approximately equal to the resonance frequency. The resonance frequency results from the resonance frequency of the piezo disc 68, the volume and the nature of the measuring cavity 54 and of the entrance openings 63. The resonance frequency can be determined beforehand in the construction or in a test, respectively. The piezo disc 68 is located in the diagonal line of a H-bridge circuit, which is not depicted. When the excitation of the piezo disc 68 is terminated, the same continues to oscillate with decaying amplitude for a certain time, as can be recognised in FIG. 3. The decay time is designated with t_{AB} in FIG. 3. In the comparator 14, the oscillations of the piezo disc 68 are converted into digital signals, as is shown in FIG. 4. The counter 16 counts the number of the impulses after the termination of the excitation of the oscillator 10. The number of impulses which still occur in a freshly produced alarm device after the termination of the excitation of the oscillator 10 is stored in the memory 20. A reduced permeability of the entrance openings 63 results in a damping of this oscillation, so that the number of impulses is decreased. This can be detected in the processor 18, which subsequently gives a signal S4 to a signal transmitter 22. In FIG. 2, S1 designates the triggering signal for the oscillator 10, S2 the parallel triggering of the counter 16 and S3 the impulse signal from the counter 16. It is to be understood that the comparator 14 and the counter 16 can be housed in the processor 18.

Further, it is to be understood that a threshold value transmitter can also be provided instead of a counter, which transmits a signal to the processor when the amplitude of the decaying oscillation reaches this threshold value or falls below it. When this takes place in a frame of time which is smaller than the time frame for the decay oscillation of the piezo disc 68 at undoubtedly opened entrance openings 63, an error signal can be generated also.

What is claimed is:

1. A method for testing the free entrance of gas into a measuring cavity of a warning alarm device via at least one opening, wherein an acoustic signal is generated in the measuring cavity and the change of the resonance behaviour of the measuring cavity is measured in order to emit an error signal when the resonance behaviour has changed in a measurable degree, characterised in that the number of the oscillations of the acoustic signal is measured after the termination of the acoustic signal, and is compared with a preset value.

2. A method according to claim 1, characterised in that the acoustic signal is generated for a short period of time.

3. A method according to claim 2, characterised in that the acoustic signal is generated with a piezo disc and the decaying oscillations of the piezo disc are counted.

4. A method according to claim 1, characterised in that the number of the decaying oscillations is counted and memorised in the new or unsoiled condition of the warning alarm device, and the oscillations counted in the testing operation are compared with the memorised number, the error signal being generated when the difference of the number of oscillations reaches a preset value.

5. A method according to claim 1, characterised in that the acoustic signal is generated in a cyclic manner, and the measurement of the decaying oscillations takes place always after the end of the acoustic signal.

6. A warning alarm device, a smoke detector in particular, with a measuring cavity featuring at least one opening, a measurement device being arranged in said measuring cavity, wherein said opening features a screen or trellis, furthermore with a sound generator in the warning alarm device, which emits an acoustic signal into the cavity, and with an error measurement device in the warning alarm device, which measures the change of the resonance behaviour in the cavity in the generation of the acoustic signal and emits an error signal when the resonance behaviour deviates from a preset value, characterised in that a control device interrupts the excitation of the sound generator and a counting device counts the number of the decaying oscillations after the interruption of the excitation of the sound generator, and the error measurement device generates an error signal when the oscillation number is below a preset value.

7. A warning alarm device according to claim 5, characterised in that the sound generator has a piezo disc (68).

8. A warning alarm device according to claim 7, characterised in that the piezo disc (68) is arranged behind an opening (69) in an upper wall (55) of the measuring cavity (54).

9. A warning alarm device according to claim 6, characterised in that the sound generator is a sound generator of the measurement device at the same time.

10. A warning alarm device according to claim 7, characterised in that the piezo disc (68) is connected in the shunt arm of an H-bridge circuit (12) which is connected to an oscillator (10).

11. A warning alarm device according to claim 7, characterised in that the piezo disc (68) is excited with the resonance frequency.

12. A warning alarm device according to claim 6, characterised in that the error measurement device features a comparator (14), which converts the decaying oscillations into digital signals.
